(19) United States
(12) Patent Application Publication
(10) Pub. No.: US 2010/0295862 A1
(43) Pub. Date: Nov. 25, 2010

(54) Method and system for accessing image data adaptively

(75) Inventor: Guo AI, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/784,566

(22) Filed: May 21, 2010

(30) Foreign Application Priority Data
May 25, 2009 (CN) 200910084705.5

(51) Int. Cl. G06K 9/36; G09G 5/397

(52) U.S. Cl. 345/546

(57) ABSTRACT

Techniques for adaptively accessing image data in a data memory space are disclosed. According to one aspect of the present invention, a data transfer bandwidth between a display controller and a memory device is detected to obtain bandwidth characteristics. An image format to be used is determined by comparing the bandwidth characteristics with a preset mapping relationship between at least two image formats and the bandwidth characteristics. A current image format is updated by the determined image format to be used if the determined image format to be used is different from the current image format. The image data in the memory is then read out according to the current image format.

### BACKGROUND OF THE INVENTION

1. Field of the Invention

The present invention relates to the field of image data transfer, more particularly to method and system for accessing image data adaptively.

2. Description of Related Art

Human's eyes are more sensitive to luminance than chrominance. Hence, YUV model is developed for encoding image or video data, in which Y stands for the luminance component (the brightness) and UV stand for the chrominance (color) components. For reducing storage space of image or video, part of UV data may be discarded directly. Specifically, all of UV data is reserved in YUV444 format, a half of UV data is reserved in YUV422 format, a quarter of UV data is reserved in YUV420 format, and none of UV data is reserved in YUV400 format (black and white pictures). The JPEG image is usually encoded by YUV422 format, and the video data is usually encoded by YUV420 usually. Currently, a liquid crystal display (LCD) controller usually utilizes a data resource of YUV422 format as an input of a liquid crystal displayer. Hence, the conventional LCD controller always reads the video data in YUV422 format from an image buffer.

In a typical electronic system (e.g., a TV) that involves a LCD, an image buffer is often used. Besides being accessed by a LCD controller for image data to be displayed on the LCD, the image buffer is likely accessed by other functional circuits. While showing a video, the bandwidth assigned to the LCD controller may be limited so that the reading speed of the LCD controller 160 may be slowed down when other circuits access the image buffer. If the data amount being read into the LCD controller is less than the data amount normally outputted to the LCD for display, the image data in an internal buffer in the LCD controller 160 may become gradually empty, causing display errors in the screen refresh of the LCD.

Thus, improved techniques for accessing image data in a data memory space are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to techniques for accessing image data in a data memory space. According to one aspect of the present invention, a data transfer bandwidth between a display controller and a memory is detected to obtain bandwidth characteristics. An image format to be used is determined by comparing the bandwidth characteristics with a preset mapping relationship between at least two image formats and the bandwidth characteristics. A current image format is updated by the determined image format to be used if the determined image format to be used is different from the current image format. The image data in the memory is read out according to the current image format.

In one embodiment, the bandwidth characteristics is data amount information in an internal buffer of a display controller, each image format corresponds to a range of the data amount information. The image format with lower compression ratio corresponds to the range of the larger data amount information.

There are many objects, features, and advantages of the present invention, which will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram showing part of functional blocks of an embedded system;

FIG. 2 is a block diagram showing an exemplary configuration of a LCD controller according to one embodiment of the present invention; and

FIG. 3 is a flow chart showing a method for accessing image data adaptively according to one embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

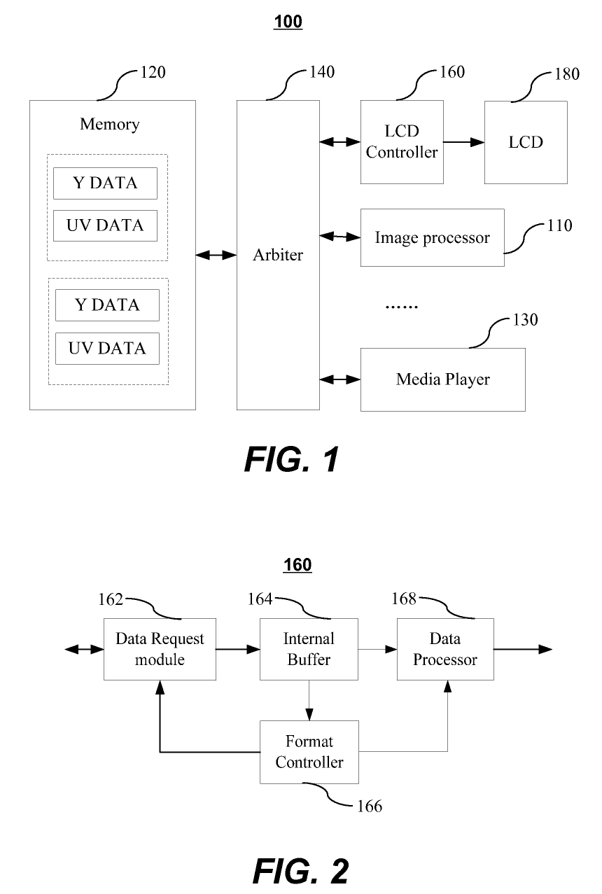

Embodiments of the present invention are discussed herein with reference to FIGS. 1-3. However, those skilled in the art will readily appreciate that the detailed description given herein with respect to these figures is for explanatory purposes only as the invention extends beyond these limited embodiments.

FIG. 1 is a block diagram showing part of functional blocks of an embedded system 100. The embedded system 100 comprises a memory 120, an arbiter 140, a LCD controller 160, a LCD 180 and an image processor 110. In this embodiment, an image data transfer between the LCD controller 160 and the memory 120 is taken as an example to explain how to adaptively adjust an image data format according to a data transfer bandwidth. Herein, the data transfer bandwidth specifically represents a bandwidth assigned to the LCD controller 160 when the LCD controller 160 requests to access the memory 120.

The memory 120 is configured for buffering image data which may be used as a data resource of at least two image data formats. The image data in the memory 120 may be YUV444 format, YUV422 format or YUV420 format etc. In one embodiment, the Y component data and the UV component data are stored separately when the image processor 110 writes the image data into the memory 120. Operationally, it is easier for the LCD controller 160 to read the Y component data and the UV component data from the memory 120 according to different YUV formats.

The arbiter 140 is configured to receive a request from one of the functional blocks (e.g. the LCD controller 160, the image processor 110 or the media player 130) and allow one functional block to access the memory 120 according to preset criteria.

The LCD 180 is configured to receive and display the image data outputted from the LCD controller 110. The LCD controller 160 is configured to detect the data transfer bandwidth between the LCD controller 160 and the memory 120 in real time to obtain current bandwidth characteristics, determine a YUV format to be used by comparing the bandwidth characteristics with a preset mapping relationship between the YUV format and the bandwidth characteristics, update a current YUV format by the determined YUV format to be used if the determined YUV format to be used is different from the current YUV format, determine a read mode according to the current YUV format and the YUV format of the image data in the memory 120 to read the image data from the memory 120 when the request for accessing the memory 120 is responded, buffer and process the image data, and finally output the processed image data to the LCD 180.

FIG. 2 is a block diagram showing an exemplary configuration of the LCD controller 160 according to one embodiment of the present invention. The LCD controller 160 comprises a data request module 162, an internal buffer 164, a format controller 166 and a data processor 168. The format controller 166 is provided for detecting the data transfer bandwidth between the LCD controller 160 and the memory 120 in real time to obtain the bandwidth characteristics, determining the YUV format to be used by comparing the bandwidth characteristics with the preset mapping relationship, informing the data request module 162 and the data processor 164 of the determined YUV format to be used if the determined YUV format to be used is different from the current YUV format.

The format controller 166 further comprises a setting unit, a detecting unit and a decision unit. The setting unit (not shown) may be a group of registers for recording the preset mapping relationship between the YUV format and the bandwidth characteristics. If the data transfer bandwidth is less than the display bandwidth of the current YUV format, the data amount wrote into the internal buffer 164 may be less than the data amount read from the internal buffer 164, thereby the data amount in the internal buffer 164 may be decreased gradually; otherwise, the data amount in the internal buffer 164 may be increased gradually. Hence, the data amount in the internal buffer 164 may be used as the bandwidth characteristics in one embodiment. Each YUV format may correspond to a range of the data amount. Specifically, the YUV format with lower compression ratio corresponds to the range of the larger data amount. For example, provided that the total space of the internal buffer 164 is X, the range of larger than X/2 may correspond to the YUV422 format, the range of X/4 to X/2 may correspond to the YUV420 format, and the range of less than X/4 may correspond to the YUV400 format.

The detecting unit detects the data transfer bandwidth in real time to obtain the bandwidth characteristics. In one embodiment, the detecting unit detects the data amount information in the internal buffer 164, which may be a data amount value (e.g. a difference value between the read pointer and the write pointer in the internal buffer 164) or a ratio value of the used space to the total space, etc.

The decision unit determines a YUV format to be used by comparing the bandwidth characteristic with the preset mapping relationship, informs the data request module 162 and the data processor 164 of the determined YUV format to be used if the determined YUV format to be used is different from the current YUV format.

The data request module 162 is provided for updating the current YUV format by the determined YUV format to be used after a message from the format controller 166 is received, determining a read mode according to the current YUV format and the YUV format of the image data stored in the memory 120 to read the image data from the memory 120 when the request for accessing the memory 120 is responded, and then writing the image data into the internal buffer 164. In one embodiment, after the message from the format controller 166 is received, the updating operation may be executed immediately or when the data transfer of one frame of image data is finished.

When the Y data and the UV data are stored in the memory 102 separately, some examples of the read mode are described hereafter for further explanation. For one example, provided that the image data in the memory 102 is YUV420 format, in which each pixel has one Y data and four pixels share one UV data, and the YUV400 format is determined to be used by the format controller 166, the data request module 162 requires to read the Y data in the memory 102 only. For another example, provided that the image data in the memory 102 is YUV422 format, in which each pixel has Y data and two pixels share one UV data, and the YUV420 format is determined to be used by the format controller 166, the data request module 162 requires to read all Y data and one every two UV data. For still another example, provided that the image data in the memory 102 is YUV444 format, in which each pixel has one Y data and one UV data, the data request module 162 requires to read all Y data and read none of the UV data, one every four UV data, one every two UV data or all UV data according to the determined YUV format by the format controller 166.

It should be noted that even when the Y data and the UV data are stored in the memory 102 together, e.g. the data sequence of the YUV422 stored in the memory 102 is YUVY YUVY YUVY YUVY etc., the data request module 162 may also determine the read mode according to the determined YUV format to be used to read the required image data from the memory 120. For an example, the YUV420 format is determined to be used by the format controller 166, the data request module 162 requires to read all Y data and half of UV data according to a read address generating rule to obtain following data sequence: YYUVYY, YYUVYY, YYUVYY etc.

The internal buffer 164 may be First-In-First-Out registers for buffering the image data read from the memory 102. The data processor 168 is provided for preprocessing the image data in the internal buffer 164 (e.g. converting the image data from the YUV format into a RGB format) and outputting the processed image data to the LCD 108 for display.

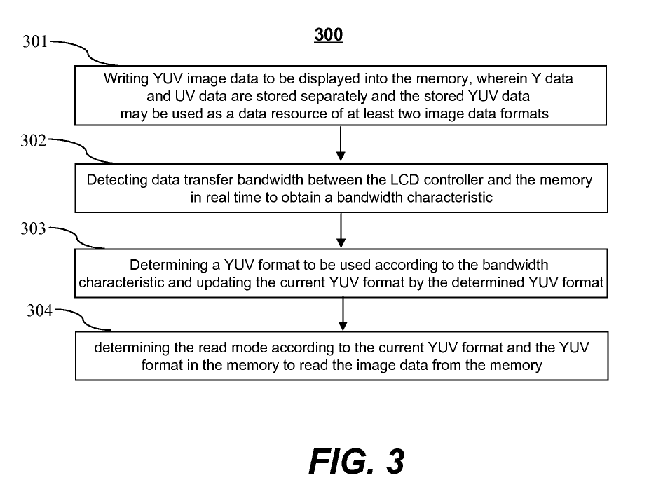

FIG. 3 is a flowchart or process 300 for accessing image data in a memory space adaptively according to one embodiment of the present invention. The process 300 may be implemented in a circuit or a system, and may be better understood in conjunction with FIG. 1 and FIG. 2.

At 301, the YUV image data to be displayed is wrote into the memory 102, wherein the Y data and the UV data are stored separately and the stored YUV data may be used as a data resource of at least two image data formats.

At 302, the LCD controller 160 detects the data transfer bandwidth between the LCD controller 160 and the memory 120 in real time to obtain the bandwidth characteristic.

At 303, the LCD controller 160 determines a YUV format to be used by comparing the bandwidth characteristic with the preset mapping relationship, updates the current YUV format by the determined YUV format if the determined YUV format is different from the current YUV format.

In one embodiment, the bandwidth characteristic obtained by the LCD controller 160 may be weighed according to C=Cₙ*α+Cₙ₋₁*(1−α), wherein C is the weighed bandwidth characteristic, Cₙ is the bandwidth characteristic detected currently, Cₙ₋₁ is the bandwidth characteristic detected lastly, and α is a weighed factor. The LCD controller 160 determines the YUV format to be used by comparing the weighed bandwidth characteristic C with the preset mapping relationship.

At 304, the LCD controller 160 determines the read mode according to the current YUV format and the YUV format of the image data in the memory 120 to read the image data from the memory 120 when the request for accessing the memory 120 is responded.

As described above, the LCD controller 160 may read the image data in the YUV format with lower compression ratio from the memory 120 for better display effect when the data transfer bandwidth is larger relatively, the LCD controller 160 may read the image data in the YUV format with higher compression ratio from the memory 120 for avoiding a display error in the screen refresh of the LCD 180 when the data transfer bandwidth is smaller relatively.

In another embodiment, an average responsive time or an accumulative responsive time of the request of the LCD controller 160 may replace the data amount information of the internal buffer 164 to be used as the bandwidth characteristic. The LCD controller 160 is configured to obtain a responsive time of each image data request, and calculate the average responsive time or the accumulative responsive time of N times of the image data requests. The smaller the average responsive time or the accumulative responsive time is, the larger the data transfer bandwidth is. Thus, each YUV format corresponds to a range of the average responsive time or the accumulative responsive time. Specifically, the YUV format with lower compression ratio corresponds to the range of the smaller average responsive time or the smaller accumulative responsive time.

A second embodiment of the present invention is described hereafter. Different from the first embodiment, the YUV format of the image data stored in the memory 120 is changeable in the second embodiment.

The LCD controller 160 also informs the image processor 110 of the determined YUV format to be used if the determined YUV format to be used is different from the current YUV format. The image processor 110 writes the image data in the determined YUV format into the memory after the message is received. Thus, it is avoided that the image processor 110 writes the image data with the lower compression ratio into the memory 120 and the LCD controller 160 reads the image data with the higher compression ratio from the memory 120.

Likewise, before the image processor 110 changes the YUV format of one frame image data into the informed YUV format, the image processor 110 may inform the LCD controller 160 of an identifier of the frame image data in the informed YUV format. The LCD controller 160 determines the read mode according to the current YUV format and the latest YUV format of the image data in the memory 120 to read the image data from the memory 120.

One of the features, objectives and advantages in the present invention is that the LCD controller may set the format of the image data read from the memory flexibly according to the current data transfer bandwidth. Thus, the enough image data for display can be obtained as much as possible to avoid the display error in the screen refresh of the LCD when the data transfer bandwidth is limited. The present invention is especially suitable for portable embedded devices such as MP4, mobile phone etc.

The ordinary people in the arts knows that the present invention is not limited to the LCD controller, and not limited to the adaptive bandwidth adjustment by converting among several YUV formats. The present invention may be used in other applications relative to the image display. Additionally, the arbiter 140 is not necessary in the present invention and all storage resource management devices provided for managing the access resource of the memories can be used in the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for accessing image data in a memory by a display controller, the method comprising:
detecting a data transfer bandwidth between the display controller and the memory to obtain bandwidth characteristics;
determining an image format to be used by comparing the bandwidth characteristics with a preset mapping relationship between at least two image formats and the bandwidth characteristics;
updating a current image format by the determined image format to be used if the determined image format to be used is different from the current image format; and
reading the image data in the memory according to the current image format.

2. The method according to claim 1, wherein the bandwidth characteristics is data amount information in an internal buffer of the display controller, each image format corresponds to a range of the data amount information, and the image format with lower compression ratio corresponds to the range of the larger data amount information.

3. The method according to claim 1, wherein the image data in the memory is able to be used as a data resource of at least two image data formats.

4. The method according to claim 1, wherein the bandwidth characteristics corresponding to the image format with lower compression ratio stands for a higher data transfer bandwidth.

5. The method according to claim 1, wherein the reading the image data in the memory according to the current image format comprises:
determining a read mode according to the current image format and an image format of the image data in the memory; and
reading the image data from the memory according to the determined read mode.

6. The method according to claim 5, wherein the image format of the image data in the memory, the current image format and the determined image format to be used all are one of YUV formats.

7. The method according to claim 6, wherein Y data and UV data are stored separately when the YUV image data is wrote into the memory.

8. The method according to claim 7, wherein the reading the image data from the memory according to the determined read mode comprises:
reading all Y data; and
reading none of the UV data, one every four UV data, one every two UV data or all UV data according to the determined read mode.

9. A system for accessing image data adaptively, the system comprising:
a memory provided for storing image data;
a display controller provided for detecting a data transfer bandwidth between the display controller and the memory to obtain bandwidth characteristics, determining an image format to be used by comparing the bandwidth characteristic with a preset mapping relationship between at least two image formats and the bandwidth characteristics, updating a current image format by the determined image format to be used if the determined image format to be used is different from the current image format, and reading the image data in the memory according to the current image format.

10. The system according to claim 9, wherein the bandwidth characteristics corresponding to the image format with lower compression ratio stands for the higher data transfer bandwidth.

11. The system according to claim 9, wherein the bandwidth characteristics is related to data amount information in an internal buffer of the display controller, each image format corresponds to a range of the data amount information, and the image format with lower compression ratio corresponds to the range of the larger data amount information.

12. The system according to claim 9, wherein the image data in the memory is able to be used as a data resource of at least two image data formats.

13. The system according to claim 9, wherein the image format of the image data in the memory, the current image format and the determined image format to be used all are one of YUV formats.

14. The system according to claim 9, wherein Y data and UV data are stored separately when the YUV image data is wrote into the memory.

15. A display controller for reading image data from a memory, the display controller comprising:
a format controller provided for detecting a data transfer bandwidth between the display controller and a memory to obtain bandwidth characteristics, determining an image format to be used by comparing the bandwidth characteristic with a preset mapping relationship between at least two image formats and the bandwidth characteristics;
an internal buffer;
a data request module provided for updating a current image format by the determined image format to be used if the determined image format to be used is different from the current image format, reading the image data in the memory according to the current image format, and writing the read image data into the internal buffer; and
a data processor provided for preprocessing the image data in the internal buffer and outputting the processed image data for display.

16. The display controller according to claim 15, wherein the image format of the image data in the memory, the current image format and the determined image format to be used all are one of YUV formats.

17. The display controller according to claim 15, wherein the bandwidth characteristic corresponding to the image format with lower compression ratio stands for the higher data transfer bandwidth.

18. The display controller according to claim 15, wherein the bandwidth characteristic is a data amount information in an internal buffer of the display controller, each image format corresponds to a range of the data amount information, and the image format with lower compression ratio corresponds to the range of the larger data amount information.
